(19) United States
(12) Patent Application Publication
(10) Pub. No.: US 2009/0164989 A1
(43) Pub. Date: Jun. 25, 2009

(54) Method for producing and application-specific installation package from device objects

(75) Inventor: Alexander Schwalbe, Pforzheim (DE)

Correspondence Address: BACON & THOMAS, PLLC, 625 SLATERS LANE, FOURTH FLOOR, ALEXANDRIA, VA, 22314-1176, US

(73) Assignee: Codewrights GmbH, Karlsruhe (DE)

(21) Appl. No.: 12/314,654

(22) Filed: Dec. 15, 2008

(30) Foreign Application Priority Data
Dec. 14, 2007 (DE) 10 2007 060990.8

(51) Int. Cl. G06F 9/445

(52) U.S. Cl. 717/178; 715/700

(57) ABSTRACT

A method for producing an application-specific installation package from device objects provided via the Internet and for integrating the installation package into an object-based, management, or configuration, system for servicing or monitoring field devices of automation technology. An original installation description file is provided via the Internet, wherein the original installation description file is downloaded onto a computer unit or onto the object-based, management, or configuration, system and started, wherein device objects needed for the installation package are interactively selected via a user interface and stored in the computer unit or in the object-based, management, or configuration, system, wherein the original installation description is copied, wherein the copy of the installation description file is stored in the computer unit or in the object-based, management, or configuration, system, together with the downloaded device objects of the field devices.

### TECHNICAL FIELD

The invention relates to a method for producing an application-specific installation package from device objects supplied via the Internet.

### BACKGROUND DISCUSSION

In process, as well as manufacturing, automation technology, field devices are often applied for registering and/or influencing process variables. Serving for registering process variables are measuring devices, such as, for example, fill-level measuring devices, flow measuring devices, pressure- and temperature-measuring devices, pH-measuring devices, conductivity measuring devices, etc., which register the corresponding process variables, fill-level, flow, pressure, temperature, pH-value and conductivity, respectively. Serving for influencing process variables are actuators, such as, for example, valves or pumps, via which e.g. flow of a liquid in a pipeline or fill-level of a medium in a container is changed. Field devices include, in principle, all devices, which are applied near to the process and which deliver, or process, process-relevant information. A large number of such field devices are available from the members of the firm, Endress+Hauser.

In modern industrial plants, field devices are, as a rule, connected via bus systems with at least one superordinated unit. Examples of suitable bus systems include the Profibus®, Foundation Fieldbus® and HART® bus systems. Normally, the superordinated unit is a control system or a control unit, such as, for example, a programmable logic controller, i.e. a PLC. The superordinated unit serves for process control, process visualization, and process monitoring, as well as for start-up and servicing of the field devices. Programs, which run independently on superordinated units, include, for example, the operating tools, FieldCare of Endress+Hauser, Pactware, AMS of Fisher-Rosemount, and PDM of Siemens. Operating tools integrated in control-system applications include PCS7 of Siemens, Symphony of ABB and Delta V of Emerson.

Integration of field devices into object-based configuration, or management, systems is accomplished via device descriptions, which enable the superordinated units to recognize and interpret the data delivered from the field devices. Device manufacturers provide the device descriptions for each of their field device types, or for each of their field device types in different applications. In order that the field devices can be integrated into different fieldbus systems, furthermore, attention must be paid to the fact that different device descriptions need to be created for the different field bus systems. Thus, there are e.g. HART-, Fieldbus Foundation- and Profibus-device-descriptions.

In order to create a universal description for field devices, Fieldbus Foundation (FF), HART Communication Foundation (HCF) and Profibus Nutzerorganization (User Organization) (acronym PNO) have defined a universal electronic device description (Electronic Device Description (EDD); this is defined in the standard IEC 61804-2.

For comprehensive servicing of field devices, recently, special device descriptions, so-called DTMs (Device Type Managers, or Device Managers) have become available. These meet the FDT (Field Device Tool) specifications. The FDT specification, serving as an industrial standard, was developed by PNO, in cooperation with ZVEI (Zentralverband Elektrotechnik-und Elektroindustrie, the translation of such being German Electrical and Electronics Manufacturers' Association). The current FDT specification can be obtained from ZVEI, PNO, or the FDT Group.

Many field device manufacturers deliver, along with their field devices, the relevant DTMs. The DTMs include all device-specific data, functions and operational rules, such as e.g. device structure, existing communication options, and a graphical user interface, or GUI, for the particular field device, or for a particular family of field devices.

As run-time environment, DTMs require a frame application, this being, here, the FDT frame. The frame application and the relevant DTMs allow for very comfortable accessing of field devices, e.g. access to device parameters, measured values, diagnostic information, status information, etc., as well as enabling the invoking of special functions made available by the particular DTMs. Frame application and DTMs form, together, an object-, or component-, based, management, or configuration, system for field devices. In order that the DTMs of different manufacturers can function correctly in the frame application, the interfaces to the frame application and to the various DTMs must be clearly defined. This matter of interfaces is an FDT concern. The FDT technology unifies the communication interface between field devices and superordinated unit. A special attraction of this technology is that it functions independently of applied communication protocol, software environment, field device, and superordinated unit. FDT technology makes it possible to create a functioning whole out of any combination of field devices, superordinated systems, and protocols. A known FDT frame application is, as already mentioned, FieldCare, a product of the firm, Endress+Hauser.

If a manufacturer has a large number of field device types, particularly field device types for various applications, in its product portfolio, then the device descriptions EDD, or the device managers DTM, can accumulate to form a significant library of device descriptions, or device managers. Device descriptions and device managers will be referred to herein, generically, as “device objects”. The library is usually delivered in the form of a Windows installation package.

To an increasing degree, installation packages are supplied via Internet. Considering that the size of today's installation packages can lie in the 800 MB range, slow Internet connections make it almost impossible for many users to download the installation packages via Internet in any reasonable amount of time. For getting around this problem, the following solutions have been proposed:

The library is divided up into smaller installation packages matched to field device types;
installation packages are separately offered for download.

These solutions have some disadvantages. The separate installation packages are, in the end, still too large for comfortable downloading. Moreover, the user must then know in which of the available installation packages the suitable device object exists for a particular field device. If this knowledge is lacking, the search for the suitable device object can be very time consuming.

An alternative solution is to install selected device objects directly from the Internet. This is problematic, taking into consideration the fact that Internet access is not available everywhere.

### SUMMARY OF THE INVENTION

An object of the invention is to provide a method for application-specific installation, or integration, of device objects into a computer unit or into a management, or configuration, system for servicing or monitoring field devices.

This object is achieved by a method comprising the following method steps:

providing an original installation description via Internet;
downloading the original installation description into a computer unit and starting the original installation description; and
interactively selecting device objects required for the installation package via a user interface of the computer unit and storing such device objects in the computer unit;
copying the original installation description;
storing the copy of the installation description file on the computer unit, together with the downloaded device objects of the field devices.

Either the device objects are copied onto the computer unit and copied from there onto e.g. the management, or configuration, system, or the method of the invention is started directly from the management, or configuration, system and executed on the system.

In a further development of the method of the invention, it is provided that the field devices are monitored or serviced via the device objects of the stored installation package stored on the management, or configuration, system. Preferably, the downloading device objects, or device managers, are provided in compressed form.

According to the invention, each installation package for an application-specific library is composed of two parts:
an installation description file with an installation logic, wherein the size of the file lies at about 600 KB; and
a plurality of compressed device objects, or device managers.

According to the invention, the installation process is started directly with the installation description file; then, a user interface is displayed for selection of the device objects. For this, the file comprised of about 600 KB is downloaded from the Internet. As soon as the user has confirmed the selection, a special program integrated in the installation description file loads the selected, preferably compressed, device objects, or device managers onto the computer unit of the user. The program generates from the original installation description file a copy and adds thereto the downloaded, selected, device objects. In this way, the copy contains only the installation description of the selected device objects, while the non-selected device objects are deactivated.

The method of the invention delivers to the user an installation package, which is identical with the original installation package, which is, however, limited to the selected, application-specific device objects, or device managers. This installation package can subsequently, without further accessing of the Internet, be installed and/or stored on another computer unit or on the management, or configuration, system.

### BRIEF DESCRIPTION OF THE DRAWINGS

The invention will now be explained in greater detail on the basis of the appended drawing, the figures of which show as follows:

FIG. 1 a schematic representation of a communication network of process automation;

FIG. 2 a method known from the state of the art for installation of a device objects library on a computer unit; and

FIG. 3 the method of the invention for installation of an application-specific device objects library on a computer unit.

### DETAILED DISCUSSION

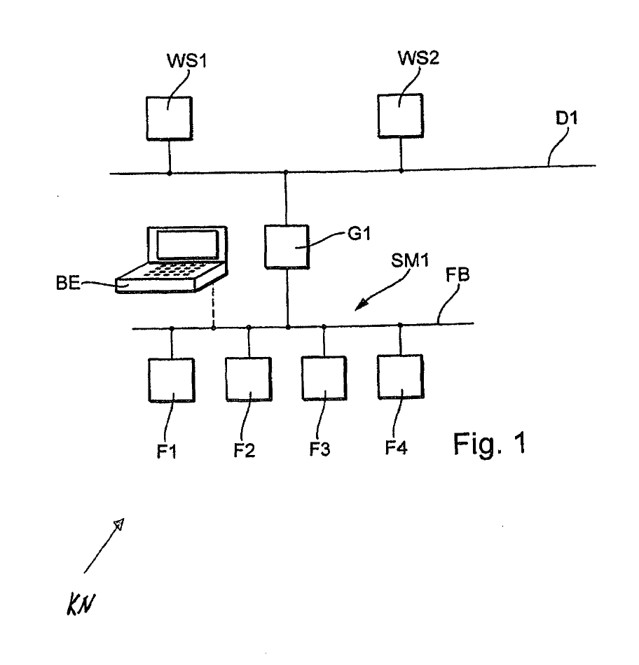

FIG. 1 shows schematically a communication network KN, such as used in process automation. Connected to a data bus D1 is a plurality of computer units (workstations, host computer) WS1, WS2. These computer units WS1, WS2 serve as superordinated units (control system, control unit, servicing unit SU) for process visualizing, process monitoring and for engineering, and, also, for the servicing and monitoring of field devices F1, F2, F3, F4.

Data bus D1 works e.g. according to the Profibus® DP standard, the HSE (High Speed Ethernet) standard of Foundation® Fieldbus, the HART standard, or some other known standard applicable for automation technology. Via a gateway G1, which is also referred to as a linking device, or segment coupler, data bus D1 is connected with a fieldbus segment SM1. Fieldbus segment SM1 is composed of a plurality of field devices F1, F2, F3, F4, which can be connected with one another via a fieldbus FB. The field devices F1, F2, F3, F4 are sensors and/or actuators. Also connectable temporarily with the fieldbus FB is a portable computer unit SU, computer 3, e.g. a laptop, via which operating personnel, or the user, can have access to the individual field devices F1, F2, F3, F4.

FIG. 2 shows a method known from the state of the art for installing a library LIB of device objects EDD, DTM on a computer unit, computer 1. If the manufacturer offers a large number of field device types, or field device types in various applications, in its product portfolio, then the device descriptions EDD or the device managers DTM together can form a device description, or device manager, library, which is quite large. Device descriptions EDD or device managers DTM are, as already explained, generically referenced as “device objects”. The library LIB is usually delivered in the form of a Windows installation package.

The size of a device objects library LIB can amount to 800 MB, which must be downloaded onto a computer unit, computer 1. In an attempt to shorten the time for downloading, libraries LIB are offered, which are divided into smaller installation packages IP matched to field device types. These installation packages IP are separately offered for download. In the illustrated case, an installation package “Fill-Level”and an installation package “Temperature” are downloaded via Internet and stored on the two computer units, computer 1 and computer 2.

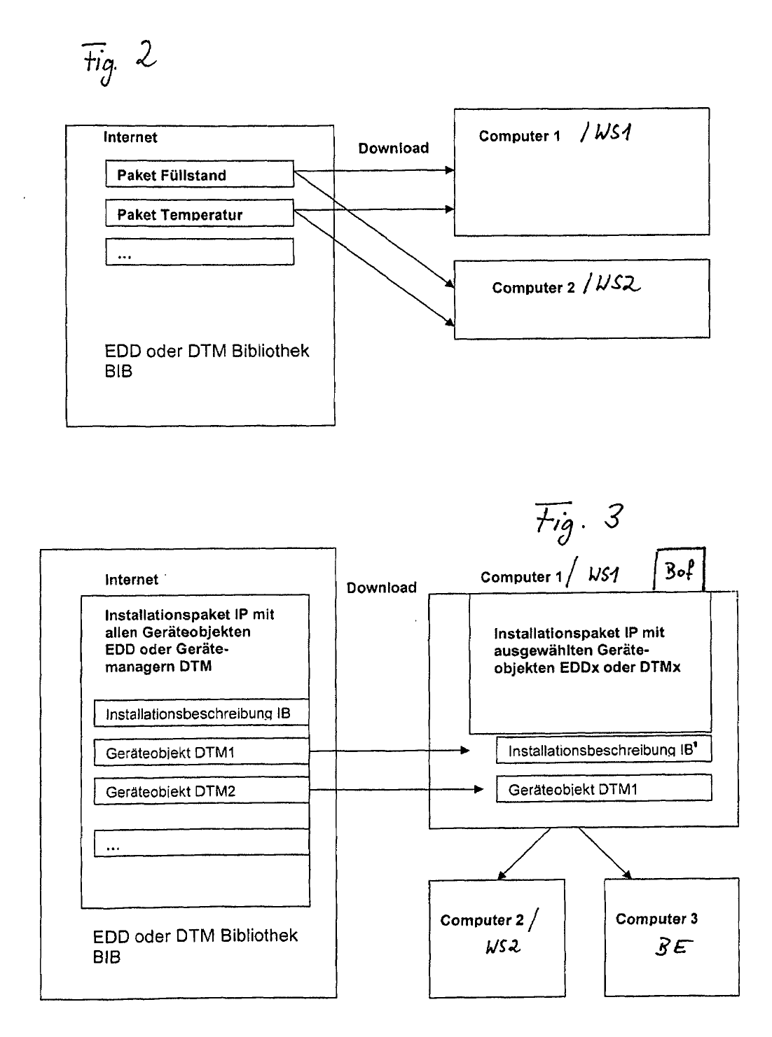

FIG. 3 presents the method of the invention for installing an application-specific, device object library LIB on a computer unit, computer 1. Via the Internet, an original installation description file ID is downloaded onto the computer unit, computer 1, and started. The computer unit, computer 1, can be an object-based, management, or configuration, system. Then, the device objects DTM1 needed for the installation package are interactively selected via a user interface UI and stored in the computer unit, computer 1, or in the object-based, management, or configuration, system WS1, WS2, SU. In a further method step, the original installation description ID is copied, and the copy ID′ of the installation description file is stored in the computer unit, computer 1, or in the object-based, management, or configuration, system WS1, WS2, SU, together with the downloaded device objects DTM1 of the field devices F1, F2, F3, F4. The stored, application-specific, installation package IP can then be copied onto the computer units, computer 2, computer 3, without any further accessing via Internet being necessary. According to the invention, a communication hardware, here the device objects DTM1, DTM2 for the field devices F1, F2, F3, F4, is linked with a servicing application, here the installation description file ID.

In this way, the user can, itself, configure, download and store from device object libraries, or from device objects, the required installation package ID. Instead of having to download a complete library of device objects EDD, DTM, it becomes possible, according to the invention, only to download selected device objects EDD, DTM and then to produce automatically an application-specific installation package IP for subsequent use.

1. A method for producing an application-specific installation package from device objects provided via the Internet and for integrating the installation package into an object-based management, or configuration, system for servicing or monitoring field devices of automation technology, comprising method steps of:
providing an original installation description file via the Internet;
downloading the original installation description file onto a computer unit or onto the object-based, management, or configuration, system and starting the original installation description file;
interactively selecting, via a user interface, device objects needed for the installation package and storing such in the computer unit, or in the object-based, management, or configuration, system;
copying the original installation description; and
storing a copy of the installation description file in the computer unit or in the object-based, management, or configuration, system, together with the downloaded device objects of the field devices.

2. The method as claimed in claim 1, wherein:
the field devices are monitored or serviced via the downloaded device objects of the stored installation package.

3. The method as claimed in claim 1, wherein:
the downloaded device objects are provided via Internet in compressed form.
